(19) United States
(12) Patent Application Publication
(10) Pub. No.: US 2003/0216985 A1
(43) Pub. Date: Nov. 20, 2003

(54) Real estate investment system and investment method

(76) Inventor: Mitsuo Kurimoto, Fucyu-Shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/373,068

(22) Filed: Feb. 26, 2003

(30) Foreign Application Priority Data
May 13, 2002 (JP) 2002-137169

(51) Int. Cl. G06F 17/60

(52) U.S. Cl. 705/35; 705/38

(57) ABSTRACT

This invention provides a real estate investment system that enables a loan agreement and establishment of a mortgage on each investor's equity to the total value of an investment.

The real estate investment system comprises a server S of an investment management institution and investors' terminals T connectable to the server of the investment management institution through the Internet. The server S of the investment management institution includes a real estate information display part 1 for displaying information related to specific real properties, an investment information display part 2 for displaying investment information used when the investors make investments in mortgaged properties, and a member personal information display part for displaying personal information on registered members. The investment information includes the number of units offered and a rate of dividend per unit so that each investor will make a real estate investment based on the real estate information display part 1 and the investment information display part 2 of the server of the investment management institution.

### BACKGROUND OF THE INVENTION

1. Field of the Invention

This invention relates to a real estate investment system and investment method, and more particularly to a real estate investment system and investment method for allowing investors to make investments in mortgaged properties at predetermined rates of return.

2. Description of the Related Art

With the decrease in the deposit rate and the removal of a ban on the payoff system, individual and institutional investors are becoming deeply interested in investment methods and investment destinations. Information on investment methods and investment destinations is typically complicated or based on complicated regulations. The conventional way of investment makes them difficult for ordinary investors to get the information and understand the regulations, or involves a burdensome procedure.

For example, when investing in a factory or apartment, the investor has to deal with a complicated buying procedure. Further, a bulk purchase of real properties involves enormous expenses, and the management of the purchased properties requires a lot of time and trouble. For these reasons, real estate investments have been conventionally made by certain limited investors.

A method of investment is therefore conceivable, which invites multiple investors for join investment in real estate. Such a joint investment by multiple investors, however, has the following problems. A renewal of a lease or the need to sign a new lease due to a change of leaseholder requires all the joint owners (that is, all the investors who applied for the investment concerned) to affix their signatures to or seals upon the lease. A change of ownership also involves a burdensome procedure. Further, all the joint owners (investors who applied for the investment) must take high risks if the property price is to fall.

This invention has been made in light of such current realities, and it is an object thereof to provide a real estate investment system and investment method as described below.

In other words, it is an object of this invention to provide a real estate investment system and investment method, which can minimize complication of a procedure when investors invest in real estate.

It is another object of this invention to provide a real estate investment system and investment method, which can offer the investors low-risk investments.

### DISCLOSURE OF THE INVENTION

To solve the aforementioned problems, a real estate investment system of this invention has the following structural features.

A real estate investment system of this invention comprises a server of an investment management institution and investors' terminals connectable through the Internet to the server of the investment management institution. The server of the investment management institution includes a real estate information display part for displaying information related to specific real properties, an investment information display part for displaying investment information used when investors make investments in mortgaged properties, and a member personal information display part for displaying personal information on registered members. This system structure features that the investors make investments in real estate based on the real estate information display part and the investment information display part of the server of the investment management institution, where the investment information display part includes at least the number of units offered and an annual rate of dividend per unit as the investment information (claim 1).

Such a structure allows the investors to invest in mortgaged properties at predetermined rates of interest, and the investment management institution to purchase and manage real properties based on the money invested by these investors. In other words, the real estate investment system of this invention is synonymous with a real estate financing system or fund raising system for purchasing real properties in view of the side of the investment management institution.

In the real estate investment system of this invention, the real estate information display part may include as expected return information an assessed value of each real property calculated by a capitalization method.

The capitalization method is a method for calculating the assessed value of the real property by dividing its annual average rental income by four percents. This method has the advantage of not causing any change in the assessed value as long as the income or proceeds from the real estate concerned remains constant even if the declared value or basic price of the real estate varies.

Also, to solve the aforementioned problems, a real estate investment method of this invention has the following structural features.

A real estate investment method of this invention is to allow investors to make investments through investors' terminals based on information related to specific real properties presented through the Internet form a server of an investment management institution. This method comprises a step of allowing the investors to access the server of the investment management institution through the terminals of the investors, a step of allowing the investors to browse real estate investment information presented from the server as investment information including the number of investment units and an annual rate of dividend per unit, a step of allowing the investors to browse information related to real properties presented from the server of the investment management institution, and a step of allowing the investors to send information related to the investors themselves and the number of order units to the server of the investment management institution based on the investment information and the information related to the real properties the investors browsed.

Such a structure allows the investors to make investments in mortgaged properties at predetermined rates of interest, and the investment management institution to purchase and manages real properties based on the money invested by these investors. In view of the side of the investment management institution, the real estate investment method is synonymous with a real estate financing system or fund raising method for purchasing real properties.

The real estate investment method of this invention may also feature that the server updates the real estate investment information in real time whenever acknowledging receipt of an application from an investor.

Such a structure enables a real-time display of data including the number of investment units decreased by the investment application or after the deadline has passed.

The real estate investment method of this invention also comprises a step of allowing each investor and the investment management institution to sing a loan agreement and establish a mortgage on the investor's equity to the total value of the investment.

Such a structure makes it possible to offer the no-loss-of-principle as long as the annual average rental income before the date of expiration remains constant, and hence minimize the investor's risk.

Further, in the real estate investment method of this invention, the investors are registered in the server of the investment management institution beforehand as password-assigned members.

Such a structure saves the investment management institution for having to repeatedly examine the investors' qualifications to make investments. On the other hand, this structure allows the investors to do membership registration and consult the operational states of real properties in which they have been invested.

The real estate investment method of this invention may further include a step of allowing the investment management institution to acknowledge receipt of money received from each investor after receiving an investment application for a certain number of investment units from the investor and send the investor a loan agreement and a duplicate copy of a property register with a certificate of settlement of a mortgage attached.

Such a structure ensures a fair procedure (loan agreement procedure) between the investment management institution and the investor.

### BRIEF DESCRIPTION OF THE DRAWINGS

FIG. 1 is a schematic diagram showing a real estate investment system of this invention.

FIG. 2 shows an example of displayed information in the real estate investment system.

FIG. 3 shows another example of displayed information in the real estate investment system.

FIG. 4 shows a still another example of displayed information in the real estate investment system.

FIG. 5 is a flowchart showing the flow of a real estate investment method according to this invention.

### BEST MODE FOR CARRYING OUT THE INVENTION

This invention will now be described in detail based on the accompanying drawings.

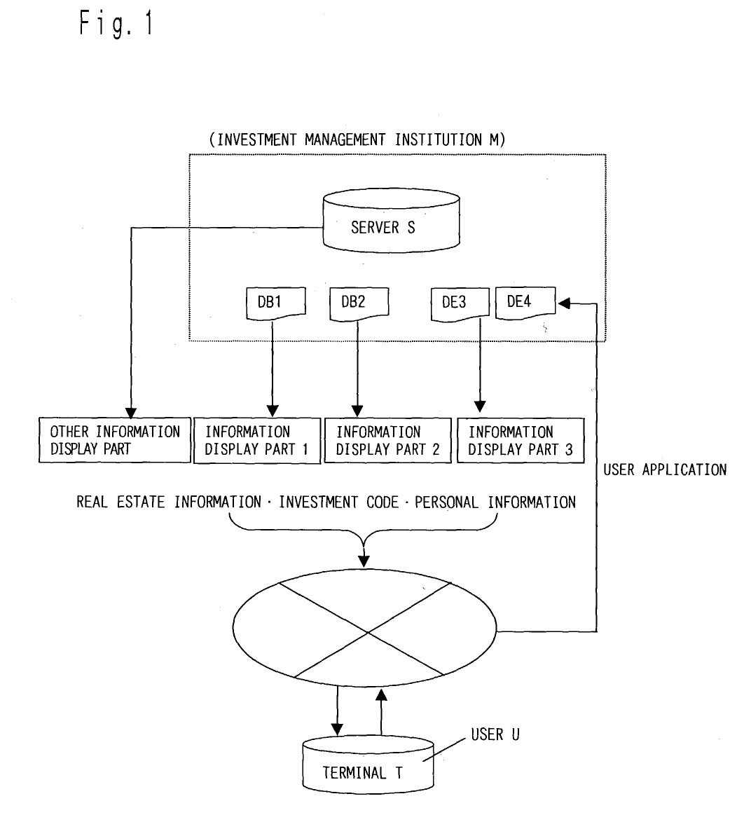

A real estate investment system according to this invention will first be described based on FIG. 1. As shown in FIG. 1, the real estate investment system of this invention is mainly constituted of a server S held by an investment management institution M and a terminal T of an investor as a user U. The server S of the investment management institution and the terminal T of the user U are connectable through the Internet INT. It should be noted that the investor may be an individual or institutional investor.

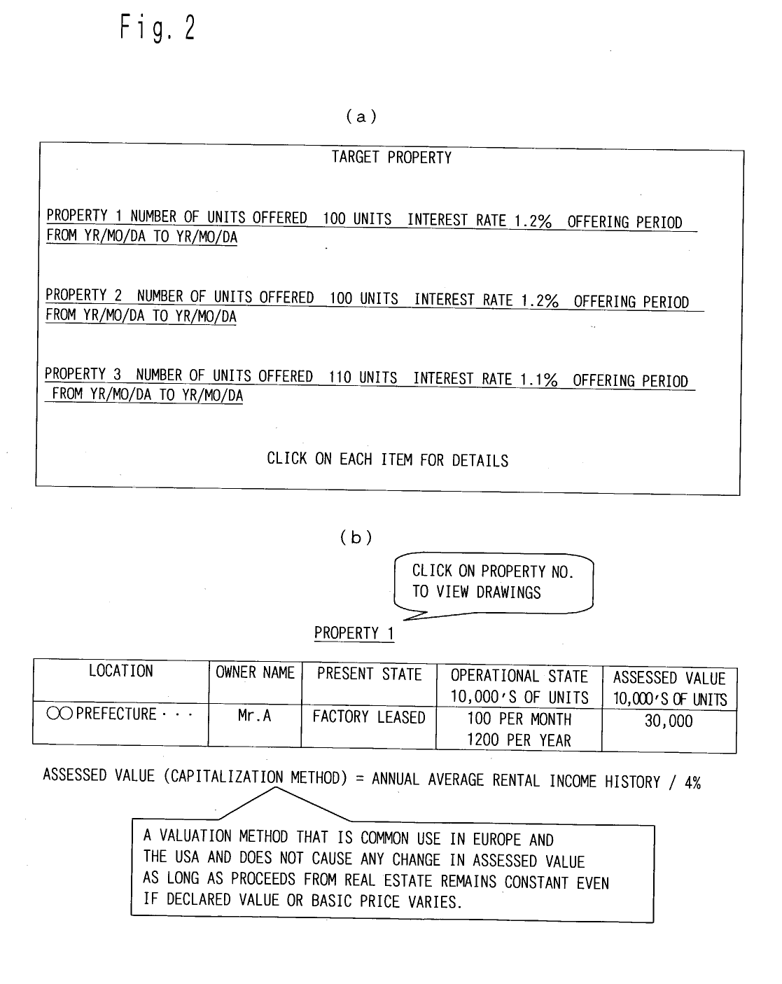

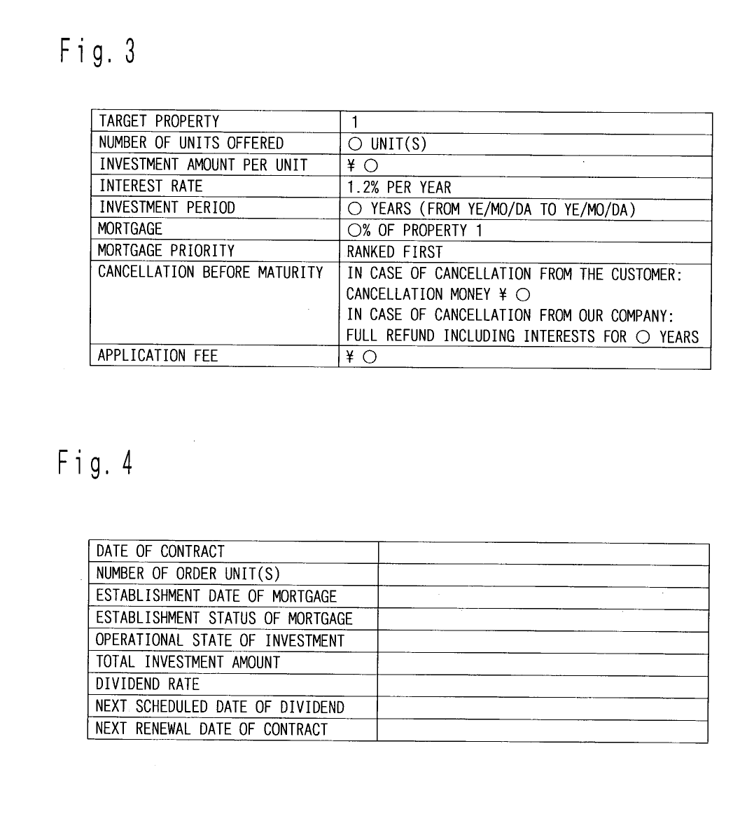

The server S of the investment management institution holds an investment outline database DB1, a summary of application database DB2, a member personal information managing database DB3, a member management database DB4, and so on. Based on these databases, outlines of real properties as described later in FIG. 2, investment information used when each investor makes an investment as described later in FIG. 3, and personal information such as member's mortgaged status or the total amount of investment based on FIG. 4 are displayed. The databases DB1 to DB3 in the server S of the investment management institution form a real estate information display part 1 for displaying information related to specific real properties, an investment information display part 2 for displaying investment information used when the investors make investments in mortgaged properties, and a personal information display part 3 for displaying personal information on users who have become investment members, respectively.

The investment outline database DB1 is a database for managing information on investment properties owned or held by the investment management institution M. For example, the database contains information on locations, owners' names, present states, operational states, and assessed values of the pieces of real estate as shown in the following table 1.

TABLE 1

| | | | | Operational | Assessed |
|---|---|---|---|---|---|
| Prop- | | | | state | value |
| erty | | | Present | 10,000's of | 10,000's |
| No. | Location | Owner Name | State | units | of units |
| 1 | . . . ◯ ◯ | Mr. A | Factory | 100 per | 30,000 |
| | Prefecture | | leased | month | |
| | | | | 1200 per | |
| | | | | year | |
| 2 | . . . ◯ ◯ | Company B | Storage | 102 per | 33,000 |
| | Prefecture | | leased | month | |
| | | | | 1224 per | |
| | | | | year | |
| 3 | . . . ◯ ◯ | Mr. C | Residence | 8 per month | 1,000 |
| | Prefecture | Mr. D | leased | 96 per year | |

According to this invention, it is preferable that the assessed value be an amount assessed by a qualified person such as a real estate appraiser using a capitalization method. The assessed value is an amount calculated by dividing an annual average rental income by four percents. In other words, the capitalization method is to determine an assessed value of real estate with respect to the profit from the real estate investment. This method has the advantage of not causing any change in the assessed value as long as the income or proceeds from the real estate concerned remains constant even if the declared value or basic price of the real estate varies. The location, owner's name or owners' names, and present state of the real estate, and information on the product commercialized by the investment management institution, such as the number of investment units and the investment period, are determined and then shown in the real estate information display part 1.

The summary of application database DB2 is a database for determining the investment period and the number of investment units based on the DB1 shown in Table 1 and managing the investment product for the investor(s) based on the determined information. For example, when the real property of property No. 1 shown in Table 1 is to be sold at 30 units at a price of one million yen per unit during a predetermined period, information as shown in Table 2 is managed.

TABLE 2

| Property | Number of | Price per | Interest | Offering | |
|---|---|---|---|---|---|
| No. | order unit(s) | unit | rate | period | User |
| 1 | 1/100 | 100 | 1.2 | | A |
| 1 | 2/100 | 100 | 1.2 | | A |
| 1 | 3/100 | 100 | 1.2 | | B |
| | . . . | | | | |
| 1 | 30/100 | 100 | 1.2 | | |
| 2 | 1/100 | 100 | 1.2 | | |
| | . . . | | | | |
| 2 | 30/100 | 100 | 1.2 | | |
| 3 | 1/110 | 50 | 1.1 | | |
| 3 | . . . | | | | |
| 3 | 10/110 | 50 | 1.1 | | |

It is preferable that the summary of application database DB2 also have a function for managing the presence or absence of a document of obligation or duplicate copy of a register for each investor after the expiration of the solicitation or offering period, as well as the function for managing the status of investors' application entries. It is also preferable that the summary of application database DB2 should be associated by property number with the DB1 and by membership number or the like with the member management database DB4 (User=Membership No. in the member management database DB4). Based on the summary of application database DB2 thus configured, investment information as shown in FIG. 3 to be described later is displayed.

The member personal information managing database DB3 is a database for managing personal information on investors who have become registered members. Only each member can access his or her own personal information. In other words, the member personal information managing database DB3 is to perform the collective management of personal information on each investor as the user U, such as membership No. (e.g., “ABC”), address (or principle place of business), name, number of order units, price per unit, establishment date of security or mortgage, operational state of investment, total amount of investment, rate of dividend, next scheduled date of dividend, and next renewal date of contract, together with a password of the user U and the like. These pieces of personal information are browsable by only the investor concerned with his or her ID and password.

On the other hand, the member management database DB4 is to perform the collective management of member personal information on each individual member, such as ID, password, application date of investment, status of money received, registration date, date of contract, and mailing date of a loan agreement (a contract of cash loan for consumption).

The real estate information display part 1 of this invention will be described below using FIG. 2.

The real estate information display part 1 is a display part that shows the user U information on target investment properties. The real estate information display part 1 is data part that makes information on the commercialized properties from the DB1 shown in Table 1 browsable on the Internet in a format such as HTML. For example, it can be formed from a list of investment choices shown in FIG. 2(a) and detailed information related to each individual property shown in FIG. 2(b).

The investment information display part 2 of this invention will next be described using FIG. 3.

The investment information is information that indicates investment amount (investment amount per unit), investment yield, statement of expected revenue and expenditure in relation to the investment, and instructions about other risks and warnings related to the investment. For example, as shown in FIG. 3, the real estate investment system of this invention can give the investor as the user U a display of, in advance of making an investment, information about an arrangement on cancellation before maturity, such as penal charge, refund, and cancellation money, and other guidelines, in addition to the number of units offered for each investment, investment amount per unit, investment yield (interest rate), and the like created based on the information shown in Table. 2 in a format browsable on the Internet such as the HTML format.

The member personal information managing database DB3 of this invention will next be described.

The personal information is information that indicates personal data for all the individual investment members. As shown in FIG. 4, the information is for the exclusive use of members, and is browsable by only each of the members with their IDs and passwords. For example, it can indicate the date of contract, number of order units, total amount of investment, rate of dividend, and other information with respect to each individual.

According to this invention, the server S of the investment management institution M contains other information display parts that indicate information necessary to inform the user U other than the outlines of real properties shown in FIG. 2 and the investment information shown in FIG. 3.

For example, the following is displayable through the terminal of the user U:

(1) information related to [System Profile] that makes it easier for the user U to understand the real estate investment system of this invention;

(2) [Membership Agreement] that includes a regulation that the user U must comply with when using the real estate investment system of this invention;

(3) [Risk Information] that includes the security of returns when the user U makes an investment using the real estate investment system of this invention;

(4) [Flowchart] that explains a procedure from the moment of an application for investment to the moment of completion of the contract in the real estate investment system of this invention;

(5) [Cancellation/Refund Information] that includes conditions in case of cancellation and refund;

(6) [Operational Information] that explains the operational state of a real property in which the user U has invested; and

(7) other information such as [FAQ] that includes frequently-asked questions to the real estate investment system of this invention.

The real estate investment system of this invention is different from securitization of real estate. The common system for securitization of real estate is to handle all aspects of the real estate management under the name of the management institution without establishment of any mortgages on investors' equities. On the other hand, in the real estate investment system of this invention, the investment management institution signs a loan agreement with each investor in a one-to-one relationship and establishes a mortgage on the investor's equity to the total value of an investment.

As stated above, one feature of the real estate investment system of this invention is that a mortgage is established between each investor and the investment management institution according to the number of units that the investor has held under a loan agreement. The mortgage is so established that all the investors are ranked as the highest priority. In general, mortgages are established in the order of registration, but all the investors are treated equally in this system. For this, a contract clause that says that all the contractants (investors) agree to be ranked as the highest priority is included in the loan agreement, and the agreement on this clause is made a condition of the contract.

The real estate investment system of this invention as configured above enables the investor as the user U to apply for investment service safely and speedily after confirmation of information related to target real properties and their predetermined interest rates and operational states. On the other hand, the system makes it possible for the investment management institution to raise funds, and hence to develop new real estate investment products, for example.

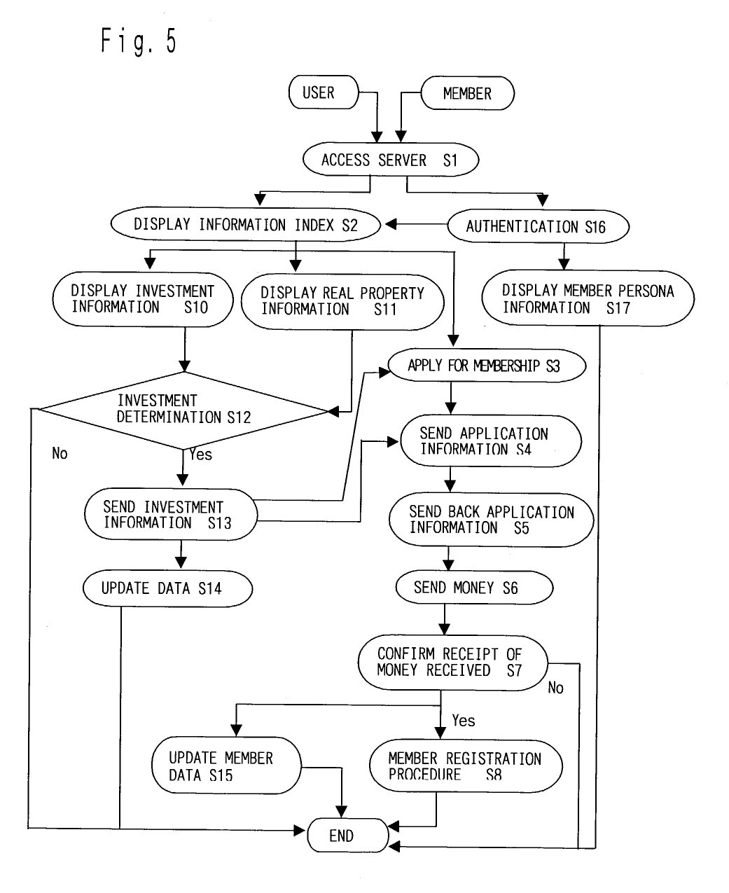

The operation of the above-described real estate investment system of this invention and real estate investment method will be described below based on FIG. 5.

FIG. 5 is a flowchart showing the flow of a real estate investment method according to this invention.

The real estate investment method of this invention is an investment method for allowing access from the terminal T of the user U to the server of the investment management institution M to make an investment based on the real estate information included in the server S.

At first, a user accesses the server of the investment management institution M (S1) to display an information index on the terminal (S2). In this method, if the user accesses the server for the first time, the investment management institution may instruct the user to do user registration. In other words, the user sends the server personal information such as his or her address, name, telephone number, facsimile number, and e-mail address to apply for user registration (S3).

Upon receipt of a membership application, the investment management institution sends HTML application information from the server to the terminal of the user who has sent the application (S4), or sends the application information to the user by any other means (mail, fax, or telephone). The application information includes a loan agreement. The investor who has received the application information sends the loan agreement signed and sealed by the investor back to the investment management institution together with other documents necessary for a contract (copy of an identification card, certificate of a seal impression, and the like) (S5). The investor also sends money to an investment management institution's account based on the information from the investment management institution (S6).

The investment management institution acknowledges receipt of the money received from the investor, the documents necessary for the contract (copy of the identification card, certificate of the seal impression, and the like), and the signed and sealed loan agreement within a predetermined period of time (S7).

If has not acknowledged receipt of the money received from the investor, the documents necessary for the contract (copy of the identification card, certificate of the seal impression, and the like), and/or the signed and sealed loan agreement after the predetermined period of time (No), the investment management institution sends a reminder to the investor to send the money and/or necessary documents. Ultimately, if not acknowledged, the registration will be cancelled.

When has acknowledged in step 8 receipt of the money received from the investor, the document necessary for the contract (copy of the identification card, certificate of the seal impression, and the like), and the signed and sealed loan agreement, the investment management institution initiates a contract procedure, that is, a procedure for establishing a mortgage. Then the investment management institution affixes a signature to and a seal upon the loan agreement, and sends the signed loan agreement back to the investor together with a duplicate copy of a property register that says that a mortgage is settled according to the investor's equity (S8). The investment management institution also issues an ID and password to the registered member. These pieces of member information are listed in the member management database DB4 shown in FIG. 1.

Any user or member can access the server of the investment management institution M through his or her terminal (S1) and display the information index on the terminal (S2) to access various kinds of information. Upon receipt of the access through the terminal of the user, the server gives a display of a menu on which the various kinds of information are listed, that is, a display of indexes such as [Outline of Real Properties], [Investment Information], [system Profile], [Membership Agreement], [Risk Information], [Flowchart], [Cancellation/Refund Information], [Operational Information], and [FAQ] (S10 and S11).

The user or member reads information including [Investment Information] (s10) and [Outline of Real Properties] (S11) from these information to determines whether to invest in a certain mortgaged property, and when has decided to invest, determine the number of units to invest and the like (S12). In other words, provided that the user or member gets a grasp on the real estate investment method of this invention (that is, provided that the user r recognizes all the information such as [Membership Agreement], [Risk Information], [Flowchart], [Cancellation/Refund Information], [Operational Information], and [FAQ]), the user or member will make an investment determination by reading the investment information and the outlines of target real properties, for example as shown in FIG. 2 and FIG. 3 respectively, to determine.

As a result of the investment determination, when has decided not to invest (No), the user or member logs out of the server to end the access. On the other hand, when has decided to invest in one or more units, the user or member sends the personal information and information on the target property, the number of order units, and the like to the server through the terminal (S13).

Upon receipt of an investment application from the user or member, the server determines whether the user is a member or not. When the user is not a member, the server recognizes that the user has also applied for membership and returns to step 3 to initiate the membership registration process. When the user is a member, the server writes the name of the investor (e.g., investor B) into the summary of application database DB2 as shown in Table 2 to update the data (S14). In the example of Table 2, since 28 units available for the property 1 changes to 27 units, the number of units available for the property 1 is updated to 27 on the next display screen.

Further, in response to the investment application from the member, the server returns to step 4 to send the investor the application information. Upon receipt of the application information, the investor sends the documents necessary for the contract to the investment management institution (S5) and sends money to the investment management institution's account based on the information from the investment management institution (S7). The investment management institution acknowledges receipt of the money received from the investor and the documents necessary for the contract within a predetermined period of time (S8) to update the data (S15). If no payment from the investor has not been received and/or no receipt of the documents necessary for the contract has not been acknowledged during the predetermined period of time (No), the procedure will be ended without update of data.

On the other hand, the registered member accesses the server of the investment management institution M (S1), and after authentication through the member's ID and password (S16), gets a display of the personal information on the terminal based on the member personal information managing database DB3 shown in FIG. 4 (S17). Viewing the personal information gives the way of confirming his or her own investment history including the date of contract, the number of order units, and the operational state of the investment.

It is apparent from the above description that the real estate investment system according to this invention allows the following:

The investors can make investments in mortgaged properties at predetermined rates of interest, while the investment management institution can purchase new target real properties based on the money invested by the investors and develop further investment products. In this system, the assessed value is an amount calculated by dividing an annual average rental income by four percents. Therefore, this system has the advantage of not causing any change in the assessed value as long as the income or proceeds from the target real estate remains constant even if the declared value or basic price of the real estate varies.

The real estate investment system according to this invention also allows the following:

The investors can make investments in mortgaged properties at predetermined rates of interest, while the investment management institution can purchase new target real properties based on the money invested by the investors and develop further investment products. In addition, the investment management institution can act on behalf of third parties to perform the management of real properties owned by the third parties.

Further, this system enables a real-time display of data including the number of investment units decreased by investment applications or after the deadline has passed.

Furthermore, this system makes it possible to secure the investment amounts within certain limits and hence minimize investors' risks.

Furthermore, this system saves the investment management institution from having to repeatedly examine investors' qualifications to make investments. On the other hand, this system allows the investors to consult the operational states of real properties in which they have been invested.

Furthermore, this system ensures a fair procedure (loan agreement procedure) between the investment management institution and each investor.

What is claimed is:

1. A real estate investment system comprises a server of an investment management institution and investor terminals connectable through the Internet to the server of the investment management institution, wherein said server of the investment management institution includes a real estate information display part for displaying information related to specific real properties, an investment information display part for displaying investment information used when investors make investments in mortgaged properties, and a member personal information display part for displaying personal information on registered members, and said investment information display part includes at least the number of units offered and an annual rate of dividend per unit as the investment information, such that the investors make investments based on said investment information display part of the server of the investment management institution.

2. A real estate investment system according to claim 1, wherein said real estate information display part includes a value of each real property assessed by a capitalization method.

3. A real estate investment method for allowing investors to make investments through investors' terminals based on information related to specific real properties presented through the Internet form a server of an investment management institution, said method comprising:
a step of allowing the investors to access the server of the investment management institution through the terminals of the investors;
a step of allowing the investors to browse or read real estate investment information including the number of investment units and an annual rate of dividend per unit;
a step of allowing the investors to browse or read information related to real properties presented from the server of the investment management institution; and
a step of allowing the investors to send personal information related to the investors themselves and the number of order units to the server of the investment management institution based on the investment information and the information related to the real properties the investors browsed or read.

4. A real estate investment method according to claim 3, wherein the server of the investment management institution updates the real estate investment information in real time whenever acknowledging receipt of an application from an investor.

5. A real estate investment method according to claim 3 or 4, further comprising a step of allowing each investor and the investment management institution to sign a loan agreement and establish a mortgage on the investor's equity.

6. A real estate investment method according to claim 3 or 4, further comprising a step of allowing each investor and the investment management institution to sign a loan agreement and establish a mortgage on the investor's equity, and a step of allowing the investment management institution to assign an ID and password to the investor registered beforehand.

7. A real estate investment method according to claim 3 or 4, further comprising a step of allowing the investment management institution to acknowledge receipt of money received from each investor and send a loan agreement and a duplicate copy of a property register that says that a mortgage is settled according to the investor's equity.

8. A real estate investment method according to claim 3 or 4, further comprising a step of allowing each investor and the investment management institution to sign a loan agreement to establish a mortgage on the investor's equity, a step of allowing the investment management institution to assign an ID and password to the investor registered beforehand, and a step of allowing the investment management institution to acknowledge receipt of money received from each investor after the investor applied for certain units of investment, and send a loan agreement and a duplicate copy of a property register that says that a mortgage is settled according to the investor's equity.
